(19) United States
(12) Patent Application Publication
(10) Pub. No.: US 2008/0041229 A1
(43) Pub. Date: Feb. 21, 2008

(54) Filter Provided With A Degassing Vent And Pocket For Collecting Body Fluids

(75) Inventor: Florence Mathieu, Anglet (FR)

Correspondence Address: YOUNG & THOMPSON, 745 SOUTH 23RD STREET, 2ND FLOOR, ARLINGTON, VA, 22202, US

(73) Assignee: B.BRAUN MEDICAL SAS, BOULOGNE BILLANCOURT (FR)

(21) Appl. No.: 11/631,949

(22) PCT Filed: Jul. 13, 2005
(86) PCT No.: PCT/FR05/01813

§ 371 Date: Jan. 9, 2007

(30) Foreign Application Priority Data
Jul. 21, 2004 (FR) 04/08088

(51) Int. Cl. B01D 35/01; B01D 24/02; B01D 69/02; B01D 29/11

(52) U.S. Cl. 96/6

(57) ABSTRACT

A filter provided with a degassing vent including an absorbing material in the form of an elongated column (28) which is surrounded by a gas- and liquid tight material (30) on the larger part thereof disposed between longitudinal ends thereof, wherein the filter has an input (38) and an output which are separated by the effective length of the column (28). The input (38) is entirely separated from an external medium by a film which is made of a liquid-tight and gas-permeable hydrophobic material and whose face opposite to the input (38) is directly accessible for the body fluids. The liquid-tight and gas-permeable hydrophobic material (32) contains a laminated non-woven matter and a polypropylene membrane. The filter is suitable for pockets collecting body fluids.

The present invention concerns a filter provided with a degassing vent intended for a bag for collecting body fluids, and also such a bag.

The invention concerns the problem of deodorisation of the gases evacuated by patients with a stoma, and it applies fundamentally to stoma bags, especially for colostomy and ileostomy.

The fluids evacuated by patients with a stoma contain solid and liquid matter, but also a certain amount of gas. If the collecting bags were not equipped with any venting device, they would inflate and create significant discomfort. For this reason, the bags are equipped with degassing vents, themselves including a filter having an adsorbent material placed in an envelope.

A first basic feature which such filters must possess is that they should not permit the passage of the gas round the adsorbent material of the filter. This result is obtained in various well known ways which do not come within the framework of the invention.

Another important feature is that the pressure drop in the filter should not be great, so that the bag does not inflate.

There are numerous filters which give complete satisfaction in the absence of liquids. However, in the presence of liquids, even in small amounts, the suspended matter may cause blockage of the filter, the adsorbent material of the filter may be saturated by the matter contained in the liquid, and the liquid may fill the interstices of the adsorbent material and create a significant pressure drop which opposes the passage of the gases, so that the filter is no longer effective for the deodorisation of the gases. The liquid may even sometimes pass through the filter and soil the clothing.

The invention concerns the protection of the filters provided with a degassing vent against the action of liquids.

It is already known to place the filters at the part of a bag which should be located highest when the bag is worn. However, since the persons wearing the bags must be able to sit and to lie down, it is not always possible to rely on this simple physical arrangement to avoid wetting of the filter by the liquids.

Such a solution is described for example in European Patent EP-294 257, which concerns a filter provided with a degassing vent arranged at an upper part of a bag and comprising a column of adsorbent material placed between two films of plastics material and opening out at two opposed edges of the bag. Entry into the filter is through a simple perforation placed in the centre. The filter is located at the upper part of the bag when the latter is worn by a person standing.

Although such a filter gives satisfaction in general for colostomy bags, it is not always satisfactory for ileostomy bags, since the evacuated matter is much more liquid.

In order to remedy this drawback, collecting bags have been produced which have a filter forming a degassing vent, and in which the path of the matter as far as the inlet of the filter is winding and includes portions intended to keep the liquid at a distance from the inlet of the filter, whatever the position in which the bag is worn.

More precisely, Patent EP-990 429 describes a filter disposed between an inlet chamber and an outlet chamber for the gas. The gas outlet chamber communicates with the atmosphere through a small orifice and the inlet chamber communicates with the inside of the collecting bag through a winding passage. The inlet of the filter is therefore relatively sheltered from the liquids owing to the protection provided by the inlet chamber. However, if in spite of the winding access path to the inlet chamber, liquid reaches the latter, for example because the person wearing the bag is lying down, the trapped liquid is likely to penetrate into the filter and compromise its functioning.

Endeavours have therefore been made to use hydrophobic materials to prevent aqueous liquids from entering the filter.

For example, U.S. Pat. No. 5,496,396 describes a filter in which the adsorbent material contains an adsorbent mixed with polytetrafluoroethylene particles, sintered and non-sintered, intended to prevent wetting. However, this arrangement does not prevent the blocking of the filter by the liquid, so that the gases can circulate only when a pressure sufficient to flush the liquid is applied.

U.S. Pat. No. 6,135,986 describes a deodorising filter which comprises a porous material placed between two walls impermeable to gases and liquids and having inlet and outlet openings, and the inlet opening is covered with a hydrophobic and oleophobic membrane which is itself covered by an additional wall which defines a space for housing a foam between the walls. According to the latter document, the hydrophobic membrane is separated by a layer of foam and an additional wall on the body fluid side.

The invention concerns an improvement to filters provided with a degassing vent, making it possible to remedy the drawback of contact of the liquid with the adsorbent material. According to the invention, before the entry into the column of adsorbent material, the gases must pass through a sheet of liquid-tight and gas-permeable hydrophobic material, of which the face opposite to the inlet is directly accessible to the body fluids.

More precisely, the invention concerns a filter provided with a degassing vent, intended for a bag for collecting body fluids, of the type which comprises an adsorbent material in the form of an elongate column surrounded, at least over its largest part disposed between its longitudinal ends, by a gas-tight and liquid-tight material, the filter having at least one inlet and at least one outlet which are separated by an effective length of column of adsorbent material. According to the invention, the inlet at least is entirely separated from the external ambience by a sheet of liquid-tight but gas-permeable hydrophobic material, of which the face opposite to the inlet is directly accessible to the body fluids.

In one embodiment, the gas-tight and liquid-tight material is in the form of a sheet, and it covers the whole column, except at the inlet and the outlet.

In one embodiment, one inlet at least is formed by a perforation passing through the column and the gas-tight and liquid-tight material on both sides of the column.

Preferably, the liquid-tight and gas-permeable hydrophobic material is selected from among a nonwoven, a membrane and a laminate formed of a nonwoven and a membrane. The nonwoven, the membrane and the laminate are advantageously oleophilic. The nonwoven and the membrane are advantageously formed of polypropylene or polyethylene.

Preferably, the gas-tight and liquid-tight material is advantageously a sheet of a polyolefin selected from among polypropylene and polyethylene.

Preferably, the liquid-tight and gas-permeable hydrophobic material is maintained at a distance from the gas-tight and liquid-tight material at least in proximity to an inlet by a spacer device.

In one embodiment, the filter comprises a plurality of inlets formed by orifices, varying in number and dimensions, and/or perforations.

In one embodiment, the filter comprises a preferential folding zone. Preferably, the preferential folding zone is constituted by a perforation of the column, elongate in shape in a direction transverse to the length of the filter.

The invention also concerns a bag for collecting body fluids, of the type which is in communication with the outside atmosphere through a filter provided with a degassing vent; according to the invention, the filter is such as indicated in the preceding paragraphs, and an outlet of the filter is at a distance from the outer limits of the bag.

In the present specification, an orifice, which can pass through only one thickness of material, for example a sheet of material impermeable to gases and liquids, is distinguished from a perforation which, applied to the filter, indicates a passage through a plurality of thicknesses, such as those of the adsorbent material and of the two sheets of material, impermeable to gases and liquids, which surround it.

Other features and advantages of the invention will be more easily understood on reading the following description of exemplary embodiments, provided with reference to the appended drawings, in which:

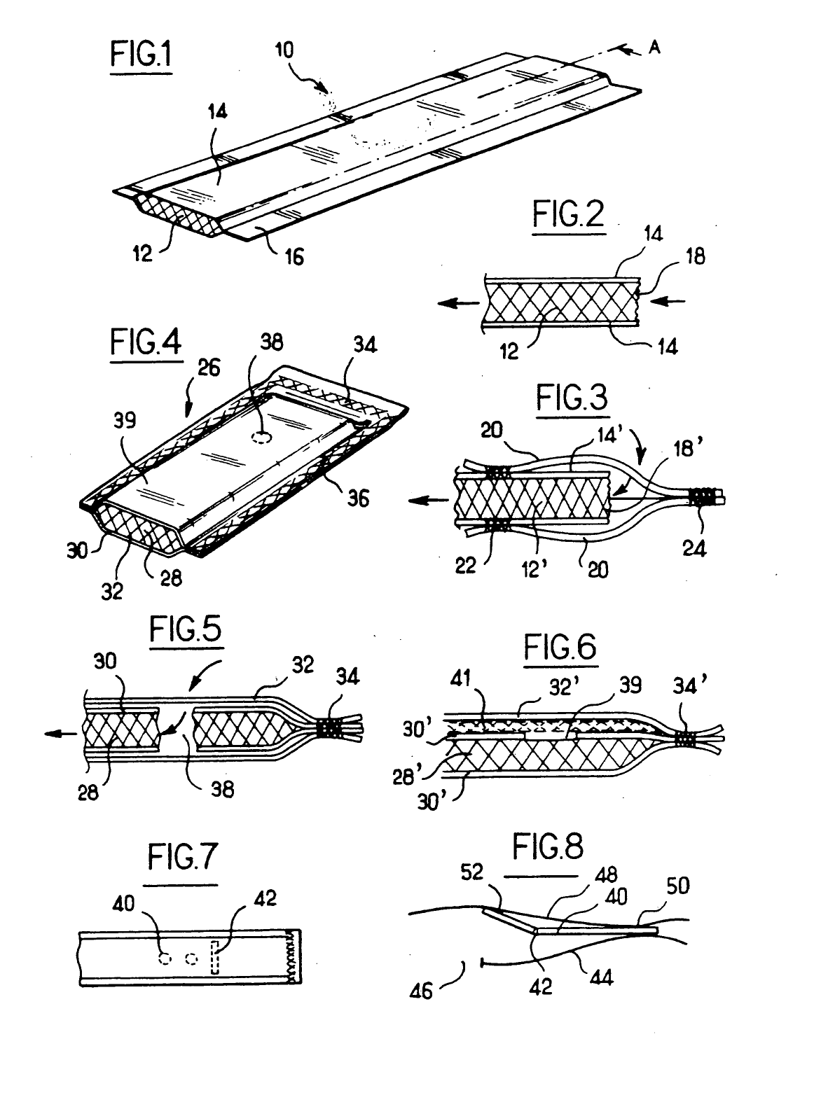

FIG. 1 is a perspective view of a simple example of a known filter;

FIG. 2 is a section through an inlet end of the filter of FIG. 1;

FIG. 3 illustrates the principle of implementation of the invention;

FIG. 4 is a perspective view of one embodiment of the invention;

FIG. 5 is a section through a part of the filter of FIG. 4;

FIG. 6 is a section analogous to FIG. 5 of a part of a filter according to another embodiment of the invention;

FIG. 7 represents an example of a filter inlet; and

FIG. 8 is a diagrammatic section through a part of a bag equipped with a filter according to the invention.

FIG. 1 shows an example of a known filter 10. A column 12 of adsorbent material, for example of active carbon, is placed between two liquid-tight and gas-tight sheets 14, welded on their edges 16. The filter causes a certain compression of the column 12 owing to the resilience of the sheets 14, so that no preferential path is formed for the passage of gas along the column 12 inside the sheets 14 between an inlet 18 and an outlet for gas. It will thus be noted in FIG. 2 that, when it has entered the inlet 18, the gas circulates in the adsorbent material of the column 12, between the sheets 14 which remain well applied to the adsorbent material. No more detailed description will be given of the co-operation between the column and the sheets which prevents the formation of a preferential path for gas along the sheets 14, since there are other means for obtaining this result, and these means have been the subject of a certain number of patents.

When such a filter is placed in an ileostomy bag, for example, which receives relatively fluid excrement, aqueous matter may come into contact with the inlet 18 of the filter column. The water may penetrate into the column and fill the interstices thereof. An obstruction may be due on the one hand to the suspended matter which clogs the interstices or pores, and on the other hand to the water which fills the pores so that a high pressure is required for the gases to emerge, so that the bag inflates. In an extreme case, the liquid may even pass through the filter and escape to the outside of the bag.

According to the invention, this problem is solved by the arrangement of a sheet of liquid-tight and gas-permeable material between the inlet and the body fluids.

FIG. 3 shows diagrammatically the principle of the invention. According to the invention, the inlet 18′ of a column 12′ of active carbon held between two sheets of gas-tight and liquid-tight plastics material 14′ is protected from the body fluids by a sheet 20 of a liquid-tight but gas-permeable hydrophobic material, fixed by welding at 22 to the sheets 14′ of the filter and at 24 to itself; thus, any direct passage between the outside of the sheet and the inlet 18′ is prohibited. In order to be able to circulate in the column 12′, the gases must have passed through the sheet 20 of gas-permeable hydrophobic material.

FIGS. 4 and 5 represent one embodiment of the invention. In this embodiment, the entry of the gases does not take place at the end of the column 28, but through the orifices of a perforation 38 formed in the column and the sheets 30 of liquid-tight and gas-tight plastics material which surround it.

At the end of the filter, the liquid-tight and gas-tight sheets 30 and the hydrophobic sheets 32 are welded at 34 and close the end in a sealed manner. Similarly, the sides are closed in a sealed manner by welds 36. For this purpose, the materials of the liquid-tight and gas-tight sheet 30 and of the liquid-tight but gas-permeable hydrophobic sheet 32 are preferably compatible so that they permit welding.

At one or more sites along the length, the sheets are of course also welded to one another so that a preferential path towards the outlet cannot be formed between the two sheets. In general, for this purpose, the filter is welded to the bag in the region 39 and, in that region, the two sheets are also welded so that the gases which pass through the hydrophobic sheet 32 cannot reach the outlet directly.

The quantity of gas which can be evacuated therefore depends on the one hand on the permeability of the sheet 32 to the gases concerned, and on the other hand on the surface area of the inlets, for example of the orifices of the perforation 38.

A membrane of ultra-high density polyethylene may be used. For example, a membrane of very porous polyethylene is known, available commercially under the name “Solupor”, having a porosity of 85% and a very high permeability to air. Owing to this high permeability, such a membrane may suffice even if it is present on only one side of the filter.

It is also possible to use a polyethylene or polypropylene nonwoven laminated to a thin membrane of polyethylene or polypropylene. For example, a polypropylene nonwoven laminated to a thin membrane of polypropylene is known, available commercially under the name “Linopore”. In the latter case, in order for welding of the hydrophobic sheet to a gas-tight and liquid-tight sheet to be effective, it is preferable for the membrane to be turned towards the gas-tight and liquid-tight sheet and for the nonwoven to be turned to the opposite side.

The more permeable the hydrophobic sheet is to gases, the smaller the orifices of the inlets may be. Most frequently, a single inlet of a few square millimetres in cross-section is sufficient. If the permeability of the hydrophobic sheet is insufficient, it is possible to increase the orifice cross-section through which the gas can penetrate. Thus, it is possible either to increase the useful surface area of the gas-permeable sheet, as described hereinafter with reference to FIG. 6, or to use a plurality of orifices or perforations, as indicated in FIG. 7, which shows an example in which two circular orifices 40 and a transversely elongate perforation 42 are formed in the column.

Owing to the high deodorising power of the adsorbent column, the length of column contained between the inlet closest to the outlet and the latter may be reduced, for example to only one or two centimetres. Thus, in FIG. 7, the part having the inlet orifices 40 and the perforation 42 may have a length of 2 cm., and the parts located on either side may also each have a length of 2 cm. Such a filter is advantageous, for example in the embodiment described in the continuation of the present specification with reference to FIG. 8. The orifices 40 may also be formed by perforations which pass through the column.

Moreover, although the presence of inlet orifices that are few in number and relatively large has been indicated, it is possible to obtain a large inlet surface area with a large or very large number of small or very small orifices, such as pores.

Although it has been indicated that the sheets were welded, they may obviously be fixed in another manner, for example by adhesive securing.

FIG. 6 is a section analogous to FIG. 5 of a part of a filter according to another embodiment of the invention. In this figure, a column 28′ of adsorbent material is surrounded by two sheets 30′ of material impermeable to gases and liquids. A single one of these two sheets has an orifice 39 which emits the adsorbent material. A sheet 32′ of liquid-tight but gas-permeable hydrophobic material is disposed towards the outside of the sheet 30′ having the orifice 39. Between these two sheets 30′ and 32′ is arranged a layer 41 of a foam very permeable to gases, constituting a spacer device and the purpose of which is to distance the sheet 32′ from the sheet 30′, while permitting the circulation of the gases parallel to the surface of the sheets 30′ and 32′.

Whereas in the embodiment of FIG. 5, only the part of the sheet 32 adjacent to the perforation 38 is actually of use for the passage of gases, in the embodiment of FIG. 6, the gases can pass through the sheet 32′ over a very large surface area before arriving at the orifice 39, by moving in the layer of foam 41 which is very permeable. It is thus possible to use a sheet of liquid-tight but gas-permeable hydrophobic material of moderate permeability, since it is active over a large surface area.

The layer 41 of foam very permeable to gases, which permits the circulation of the gases, is advantageously an open cell foam, for example, of polyurethane or polyethylene. It may be adhesively secured to at least one of the sheets adjacent to it, for example by means of a hot-melt adhesive. It may be reinforced by a polyamide grid, similar to a fine net. The orifice or orifices such as 39 may also be formed in the foam.

Although a layer of foam has been described for distancing the two sheets 30′ and 32′ from each other, any other equivalent spacer device may be used, in so far as it permits an increase in the actually useful surface area of the gas-permeable hydrophobic sheet.

Although the arrangement of the layer of foam on only one side of the filter has been described, it may be placed on both sides thereof.

FIG. 7 shows an additional feature. When the filter is fixed in a bag, it is normally welded to the walls of the bag in proximity to the outlet, and it is also most often fixed at another site. Since the filter has a certain thickness and therefore a certain rigidity, it may be advantageous to allow it to fold at a site upstream of at least one inlet to prevent folding from causing too great a pressure drop, or even from completely blocking the filter while preventing any degassing. This feature of preferential folding may advantageously be obtained by the formation of elongate perforations such as the perforation 42. Thus, this perforation allows the filter to move during the deformation of the bag, so that the permeable sheet remains to a great extent distanced from the walls of the bag to permit the entry of the gases. Preferably, each perforation, such as 42, is narrow enough for the two hydrophobic sheets placed on both sides of the filter not to be able to come into contact with each other, since the penetration of the gases would become zero in the parts in contact.

It might be feared that the impermeable walls of the associated bag and the liquids contained in the bag would not be in contact with the hydrophobic film and thus do not prevent penetration of the gas through the inlets. It is therefore desirable for the filter to have a tendency to distance itself from the walls of the bag and the matter which the bag may contain.

FIG. 8 shows an embodiment of a filter incorporated in a bag which solves the problem thus posed. In this example, a filter as represented in FIG. 7 is disposed between an inner wall 44 of the bag (on the same side as the patient's skin) having an orifice 46 for the stoma, and an outer wall 48. It is welded at 50 to the two walls so that its outlet opens to the atmosphere, but preferably short of the edge of the walls 44 and 48.

A site close to the inner end of the filter is fixed to the outer wall, for example by a weld spot or a spot of adhesive 52. Since the filter has a perforation 42 which constitutes a preferential folding site, when the walls 44 and 48 of the bag move away from each other, the end of the filter follows the outer wall 48 while folding the filter at the elongate perforation 42.

It will thus be noted that, in the position shown in FIG. 8, which corresponds to the case of a patient lying down, the filter distances itself on the one hand from the matter retained in the bag (which matter is not shown), and on the other hand from the outer wall 48 itself, so that a large surface area of the inlets of the filter is available for the passage of the gases, even in the presence of a large quantity of liquids.

In order to facilitate this deformation, it is possible to stiffen the parts which should not fold, for example by local reinforcement of the lateral welds of the filter (increase of width, insertion of a reinforcing rod, addition of a continuous or discontinuous layer to the gas-tight and liquid-tight material on one side of the filter, etc.).

The behaviour of the filter may thus be controlled on the one hand by creating preferential folding zones, such as the elongate perforation 42, and on the other hand zones of preferential reinforcement of the filter.

It has been indicated that the adsorbent column was formed of active carbon. Other well known adsorbent materials may of course be used, their essential features being to fix hydrogen sulphide.

It is of no use for the filter to be placed in a bag of the type described in Patent EP-990 429, that is to say, between an inlet chamber and an outlet chamber for gas, the inlet chamber being connected to the rest of the bag by a winding path, since it is sufficient for the filter not to be always in contact with the liquid at the inlets. It is therefore preferable for the filter to be disposed at a site in the bag which is not constantly filled with the body fluids.

Various modifications may of course be applied by an expert in the field to the filters and bags which have just been described solely by way of non-limiting example, without departing from the framework of the invention.

1. A filter provided with a degassing vent, intended for a bag for collecting body fluids, of the type which comprises an adsorbent material in the form of an elongate column (28) surrounded, at least over it largest part disposed between its longitudinal ends, by a gas-tight and liquid-tight material (30), the filter having at least one inlet (38, 40, 42) and at least one outlet which are separated by an effective length of column (28) of adsorbent material, characterized in that the inlet (38, 40, 42) at least is entirely separated from the external ambience by a sheet of liquid-tight but gas-permeable hydrophobic material (32), of which the face opposite to the inlet (38, 40, 42) is directly accessible to the body fluids.

2. A filter according to claim 1, characterized in that the gas-tight and liquid-tight material (30) is in the form of a sheet, and that it covers the whole column (28), except at the inlet (38, 40, 42) and at the outlet.

3. A filter according to claim 1, characterized in that one inlet at least is formed by a perforation (42) passing through the column (28) and the gas-tight and liquid-tight material (30) on both sides of the column.

4. A filter according to claim 1, characterized in that the liquid-tight and gas-permeable hydrophobic material (32) is selected from among a nonwoven, a membrane and a laminate formed of a nonwoven and a membrane.

5. A filter according to claim 1, characterized in that the liquid-tight and gas-permeable hydrophobic material (32′) is maintained at a distance from the gas-tight and liquid-tight material (30′) at least in proximity to an inlet (39) by a spacer device (41).

6. A filter according to claim 1, characterized in that the inlet comprises a large number of small orifices.

7. A filter according to claim 1, characterized in that the filter comprises a plurality of inlets (38, 40, 42) formed by perforations of the column and of the gas-tight and liquid-tight material (30).

8. A filter according to claim 7, characterized in that it comprises a preferential folding zone (42).

9. A filter according to claim 8, characterized in that a preferential folding zone (42) is constituted by a perforation (42) of elongate shape in a direction transverse to the length of the filter.

10. A bag for collecting body fluids, of the type which is in communication with the external atmosphere through a filter provided with a degassing vent, characterized in that the filter is according to claim 1, and an outlet of the filter is at a distance from the outer limits of the bag.

11. A filter according to claim 2, characterized in that one inlet at least is formed by a perforation (42) passing through the column (28) and the gas-tight and liquid-tight material (30) on both sides of the column.

12. A filter according to claim 2, characterized in that the liquid-tight and gas-permeable hydrophobic material (32) is selected from among a nonwoven, a membrane and a laminate formed of a nonwoven and a membrane.

13. A filter according to claim 2, characterized in that the liquid-tight and gas-permeable hydrophobic material (32′) is maintained at a distance from the gas-tight and liquid-tight material (30′) at least in proximity to an inlet (39) by a spacer device (41).

14. A filter according to claim 2, characterized in that the inlet comprises a large number of small orifices.

15. A filter according to claim 2, characterized in that the filter comprises a plurality of inlets (38, 40, 42) formed by perforations of the column and of the gas-tight and liquid-tight material (30).

16. A filter according to claim 1, characterized in that it comprises a preferential folding zone (42).

17. A filter according to claim 2, characterized in that it comprises a preferential folding zone (42).
